(19) United States
(12) Patent Application Publication
(10) Pub. No.: US 2025/0337077 A1
(43) Pub. Date: Oct. 30, 2025

(54) ASSEMBLY STRUCTURE OF BATTERY CONNECTOR, BATTERY UNIT, AND SUPPORT STRUCTURE OF BATTERY UNIT

(71) Applicant: ISUZU MOTORS LIMITED, Yokohama-shi (JP)

(72) Inventors: Kazuhiro UEDA, Fujisawa-shi (JP); Hiroshi YAMADA, Fujisawa-shi (JP); Shuhei KONISHI, Fujisawa-shi (JP)

(21) Appl. No.: 19/047,905

(22) Filed: Feb. 7, 2025

(30) Foreign Application Priority Data
Apr. 30, 2024 (JP) 2024-073930

(51) Int. Cl. H01M 50/244; H01M 50/249; H01M 50/264

(52) U.S. Cl. CPC H01M 50/244; H01M 50/249; H01M 50/264; H01M 2220/20

(57) ABSTRACT

An assembly structure of a battery connector, a battery unit, and a support structure of a battery unit each including the following: a battery cover storing a battery pack and including a standing wall provided with an opened through-hole extending from the outer side to the inner side; a battery connector including a pilot hole at a position corresponding to the through-hole; a fastener including screw and head portions; and a plate including an outer surface to which the head portion is fixed at a position corresponding to the pilot hole. The battery connector is fastened to the outer side of the standing wall by the fastener with the screw portion passing through the through-hole and the pilot hole from the inner side to the outer side, and a waterproof section disposed between the battery cover and the plate so as to surround the through-hole is further included.

This application is entitled to (or claims) the benefit of Japanese Patent Application No. 2024-73930, filed on Apr. 30, 2024, the disclosure of which including the specification, drawings and abstract is incorporated herein by reference in its entirety.

### TECHNICAL FIELD

The present disclosure relates to an assembly structure of a battery connector, a battery unit, and a support structure of a battery unit.

### BACKGROUND ART

Vehicles such as electric vehicles and hybrid vehicles are equipped with an electric motor as a drive source and a battery unit as an electric power source for driving the electric motor.

For example, the battery unit includes a battery pack, a battery case, a battery cover, a connector, and a bus bar. The battery case includes an accommodation section that accommodates a battery pack. The battery pack includes a plurality of battery modules. The accommodation section is open on a front side. The battery cover includes a wall section. After the battery pack is accommodated in the accommodation section, the battery cover is assembled to the battery case so that the wall section covers the accommodation section from the front side. The battery connector is disposed on the outer surface side of the wall section. The battery connector is fastened to the battery cover by a fastener. A stud bolt welded to the plate is used as the bolt.

Further, as an assembly structure of a battery connector, for example, a structure having satisfactory water-tightness of the battery unit has been proposed as follows: a bolt hole provided in a plate is formed in a bag shape, and a waterproof seal is disposed between the plate and the battery connector, thereby preventing water such as rainwater adhering to a wall section from moving from the battery connector side to the accommodation section side.

Further, for example, there is a battery unit including the following components: a battery module, an upper frame member that holds the battery module in a suspended state, a battery case that accommodates the battery module held by the upper frame member, a battery cover that covers an upper opening of the battery case, and a seal member that seals the battery case and the battery cover, and it is described that the water-tightness of the battery unit is obtained (see PTL 1).

### CITATION LIST

### Patent Literature

### PTL 1

Japanese Patent Application Laid-Open No. 2017-165301

### SUMMARY OF INVENTION

### Technical Problem

In the above-described assembly structure of a battery connector, when there is no space on the back side of the battery connector, it may be difficult to have satisfactory water-tightness because the bolt hole provided in the plate cannot be formed in a bag shape.

Further, in the battery unit described in PTL 1, it may become difficult to achieve satisfactory water-tightness because depending on the form of the battery unit or the like, a sealing material cannot be used.

As a result, it becomes difficult to achieve satisfactory water-tightness.

An object of the present disclosure is to provide an assembly structure of a battery connector, a battery unit, and a support structure of a battery unit, each of which have satisfactory water-tightness.

### Solution to Problem

In order to achieve the above object, an assembly structure of a battery connector in the present disclosure includes:
a battery cover that stores a battery pack and includes a standing wall provided with an opened through-hole extending from an outer side of the standing wall to an inner side of the standing wall;
a battery connector that is provided at the battery cover and includes a pilot hole at a position corresponding to the through-hole;
a fastener that includes a screw portion and a head portion; and
a plate that includes an outer surface to which the head portion is fixed at a position corresponding to the pilot hole,
in which
the battery connector is fastened to the outer side of the standing wall by the fastener with the screw portion of the fastener passing through the through-hole and the pilot hole from the inner side to the outer side, and
the assembly structure further includes a waterproof section disposed between the battery cover and the plate so as to surround the through-hole.

A battery unit in the present disclosure includes:
the assembly structure described above;
a battery case that includes an accommodation section accommodating the battery pack; and
a battery cover that includes the standing wall and is disposed so that the inner side of the standing wall is a side of the accommodation section.

A support structure of a battery unit in the present disclosure includes:
a restraint member that restrains the battery unit described above in a state where the battery unit is drawn toward a vehicle side so that, when the battery unit is drawn toward the vehicle side with a predetermined force, the battery unit receives a reaction force against the predetermined force.

### Advantageous Effects of Invention

According to the present disclosure, it is possible to achieve satisfactory water-tightness.

### BRIEF DESCRIPTION OF DRAWINGS

FIG. 1 is a plan view illustrating a frame structure of a vehicle in an embodiment of the present disclosure;

FIG. 2 is a side view illustrating the frame structure of the vehicle in the embodiment of the present disclosure;

FIG. 3 is a perspective view illustrating a support structure for a battery (herein also simply referred to as “battery support structure”) in the embodiment of the present disclosure;

FIG. 4 is a perspective view illustrating the battery support structure according to the embodiment of the present disclosure;

FIG. 5 is a plan view illustrating the battery support structure in the embodiment of the present disclosure;

FIG. 6 is a plan view illustrating the battery support structure when a frame is seen through in the embodiment of the present disclosure;

FIG. 7 is a plan view illustrating support structures for a pair of batteries in the embodiment of the present disclosure;

FIG. 8 is a plan view illustrating the support structures for a pair of batteries when frames are seen through in the embodiment of the present disclosure;

FIG. 9 is a plan view illustrating a restraint member and the like in the embodiment of the present disclosure;

FIG. 10 is a plan view illustrating the restraint member or the like when the frame is seen through in an embodiment of the present disclosure;

FIG. 11 is a perspective view illustrating the restraint member and the like in the embodiment of the present disclosure;

FIG. 12 illustrates the relationship between the position of a latch and the position of a lock pin;

FIG. 13 illustrates the relationship between the position of an output rod and the position of a link;

FIG. 14 is a plan view illustrating the battery support structure in the embodiment of the present disclosure;

FIG. 15 is a plan view illustrating an elastic member and the like in the embodiment of the present disclosure;

FIG. 16 is a side view illustrating the battery support structure in the embodiment of the present disclosure;

FIG. 17 is a plan view illustrating the battery support structure when the frame is seen through in the embodiment of the present disclosure;

FIG. 18 is a front view of the battery support structure in the embodiment of the present disclosure as viewed from a front side of a vehicle;

FIG. 19 is a perspective view of an assembly structure of a battery connector in the embodiment of the present disclosure as viewed from the other side in the oblique short direction;

FIG. 20 is a partially exploded perspective view of a part of the assembly structure of the battery connector in the embodiment of the present disclosure as viewed from one side in the oblique short direction;

FIG. 21 is a partial cross-sectional view partially illustrating a cross section of the assembly structure of the battery connector in the embodiment of the present disclosure along the up-down direction; and

FIG. 22 illustrates movement of moisture illustrated on a partial cross-sectional view partially representing a cross section of the assembly structure of the battery connector in the embodiment of the present disclosure along the up-down direction.

### DESCRIPTION OF EMBODIMENTS

Hereinafter, an embodiment of the present disclosure will be described with reference to the drawings. A vehicle in the embodiment of the present disclosure is a commercial electric vehicle used for purposes such as cargo delivery, and includes a frame structure, a motor for traveling, and a battery for driving (also simply referred to as “driving battery”). However, the present disclosure is not limited to application in commercial electric vehicles and may also be applied to general electric vehicles. The driving battery is a battery for supplying electric power to a motor for traveling. The battery support structure in the embodiment of the present disclosure is a support structure that supports the battery on the frame structure side.

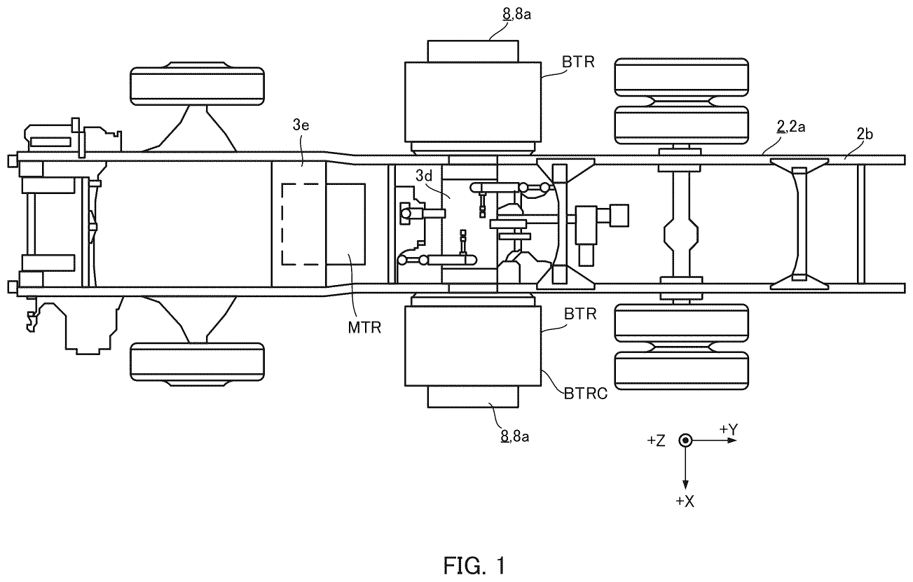

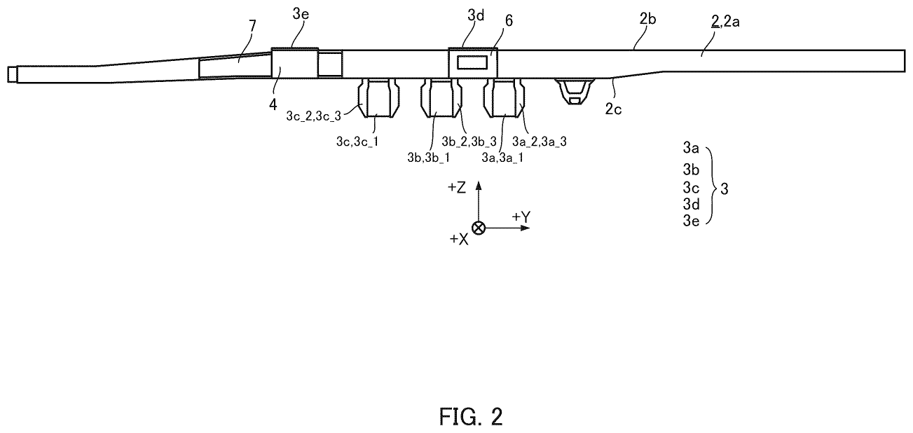

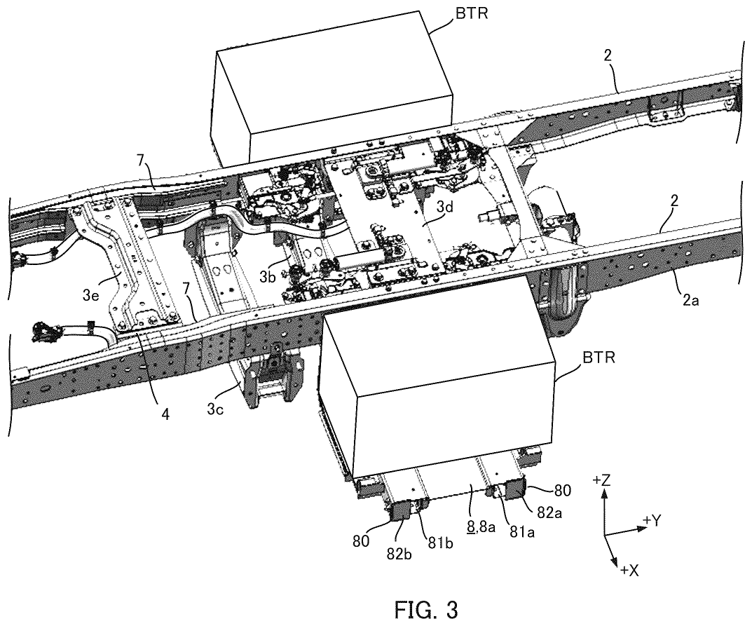

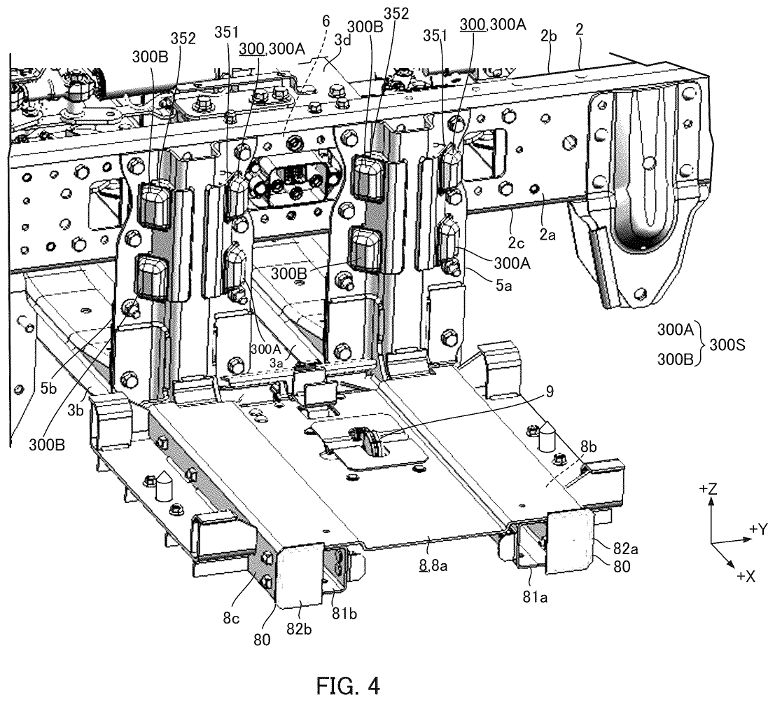

FIG. 1 is a plan view illustrating a frame structure of a vehicle in an embodiment of the present disclosure. FIG. 2 is a side view illustrating the frame structure of the vehicle in the embodiment of the present disclosure. FIG. 3 is a perspective view illustrating a battery support structure according to the embodiment of the present disclosure. FIG. 4 is a perspective view illustrating the battery support structure in the embodiment of the present disclosure. FIG. 1 illustrates an X axis, a Y axis, and a Z axis. The up-down direction in FIG. 1 is referred to as the vehicle width direction or an X direction, the direction away in the vehicle width direction from the center (in the vehicle width direction) side is referred to as the vehicle width direction outer side (i.e., outer side in the vehicle width direction) or the “+X direction,” and the direction approaching in the vehicle width direction to the center (in the vehicle width direction) side is referred to as the vehicle width direction inner side (i.e., inner side in the vehicle width direction) or the “−X direction.” The left-right direction in FIG. 1 is referred to as the vehicle front-rear direction or the Y direction, the right direction is referred to as the vehicle rear side, the vehicle rear direction, or the “+Y direction,” and the left direction is referred to as the vehicle front side, the vehicle front direction, or the “−Y direction.” The depth direction in FIG. 1 is referred to as the vehicle height direction, the up-down direction, or the Z direction, a direction in the drawing toward a viewer is referred to as the upward direction, the upper side, or the “+Z direction,” and a direction in the drawing away from the viewer is referred to as the downward direction, the lower side, or the “−Z direction.”

### (Frame Structure)

As illustrated in FIGS. 1, 2, 3, and 4, the frame structure includes a pair of frames 2 (side members), cross members 3a, 3b, 3c, 3d, and 3e, brackets 4, brackets 5a, brackets 5b, brackets 6, and closing frames 7. Brackets 4 are disposed at the same position in the vehicle front-rear direction (Y direction) in the pair of frames 2, respectively. In other words, brackets 4 are disposed at positions symmetrical to each other in the vehicle width direction (X direction) of the pair of frames 2, respectively. Similarly to brackets 4, brackets 5a, brackets 5b, brackets 6, and closing frames 7 are disposed at positions symmetrical to each other in the vehicle width direction (X direction) of the pair of frames 2, respectively.

Bracket 4 is a flat plate-shaped bracket having a substantially rectangular outer shape. Bracket 4 is disposed with the flat plate surface thereof facing the vehicle width direction (X direction). Bracket 4 is used when fastening frame 2 and closing frame 7.

Bracket 5a is a flat plate-shaped bracket having a substantially rectangular outer shape. Bracket 5a is disposed with the flat plate surface thereof facing the vehicle width direction (X direction). An upper portion of bracket 5a is fastened to groove wall 2a (see FIG. 3) having a substantially U-shaped cross section in frame 2. The lower portion of bracket 5a is fastened to cross member 3a and to mounting table 8 (see FIG. 3). Mounting table 8 is a table for mounting battery BTR (see FIG. 3). That is, cross member 3a and bracket 5a are disposed at a predetermined position in the vehicle front-rear direction where battery BTR is disposed. As illustrated in FIGS. 1 and 3, two batteries BTR are attached on vehicle 1. One of the batteries BTR is attached on one of the pair of frames from the outer side in the vehicle width direction. On the other hand, the other one of the batteries BTR is attached on the other one of the pair of frames from the outer side in the vehicle width direction.

Bracket 5b is disposed on the vehicle front side (−Y direction) compared to bracket 5a. Bracket 5b is a flat plate-shaped bracket having a substantially rectangular outer shape, similar to bracket 5a. Bracket 5b is disposed in the same manner as bracket 5a, with the flat plate surface thereof facing the vehicle width direction (X direction). An upper portion of bracket 5b is fastened to groove wall 2a of frame 2 (see FIG. 3). The lower portion of bracket 5b is fastened to cross member 3b and to mounting table 8 (see FIG. 3). That is, cross member 3b and bracket 5b are disposed at a predetermined position in the vehicle front-rear direction in the same manner as cross member 3a and bracket 5a, where battery BTR is disposed.

Bracket 6 (see FIG. 2) is a flat plate-shaped bracket having a predetermined outer shape. Bracket 6 is disposed with the flat plate surface thereof facing in the up-down direction (Z direction). An end portion of bracket 6 on the vehicle width direction outer side (+X direction) is fastened to groove wall 2b of frame 2 (see FIG. 4). An end portion of bracket 6 on the vehicle width direction inner side (−X direction) is fastened to cross member 3d. The position in the vehicle front-rear direction at which bracket 6 is disposed is a central position between the position in the vehicle front-rear direction at which bracket 5a is disposed and the position in the vehicle front-rear direction at which bracket 5b is disposed. That is, similar to cross member 3a, bracket 5a, cross member 3b, and bracket 5b, bracket 6 and cross member 3d are disposed at a predetermined position in the vehicle front-rear direction at which battery BTR is disposed.

The pair of frames 2 each extend in the vehicle front-rear direction and are disposed to be separated from each other in the vehicle width direction. Frame 2 is formed in a groove shape having a U-shaped cross section with the opening of the frame facing the vehicle width direction inner side (−X direction), and includes groove wall 2a that extends in the up-down direction (Z direction), groove wall 2b that is bent at the upper end of groove wall 2a and extends in the −X direction, and groove wall 2c that is bent at the lower end of groove wall 2a and extends in the −X direction. That is, the pair of frames 2 is disposed so that the openings thereof having a groove shape face each other in the vehicle width direction (X direction).

Cross members 3a, 3b, 3c, 3d, and 3e are disposed at a predetermined interval from each other and are mounted between the pair of frames 2. Cross members 3a, 3b, 3c, 3d, and 3e are collectively referred to as cross member 3 (see FIG. 2).

The frame structure in the present embodiment further includes closing frames 7. Closing frame 7 is provided in the opening of frame 2 and forms a cross-sectional shape closed by frame 2 and closing frame 7. As a result, it is possible to reinforce the frame structure. In the following description, a closed cross-sectional shape formed by frame 2 and the closing frame is referred to as a “closed cross-sectional shape.”

The frame structure in the present embodiment is subject to various restrictions for satisfactory disposition space for battery BTR, electric motor MTR, and the like to be disposed in frame 2. For example, the vehicle rear side end portion of closing frame 7 is shortened. Such a configuration reduces the strength of the frame structure. Therefore, in the embodiment of the present disclosure, as illustrated in FIG. 3, the vehicle rear side end portion of closing frame 7 is fastened to frame 2 with bracket 4 and a fastener (bolt, nut). Further, cross member 3e is mounted between the pair of frames 2 at a position in the vehicle front-rear direction where the vehicle rear end portion of closing frame 7 and frame 2 is fastened. As a result, it is possible to reinforce the frame structure.

Cross member 3a is formed to have a U-shaped cross-sectional shape with the opening thereof facing upward (+Z direction), and includes bottom wall 3a_1 that extends in the vehicle width direction (X direction), one side wall 3a_2 that is bent at one end of bottom wall 3a_1 on the vehicle width direction outer side and extends upward, and the other side wall 3a_3 that is bent at the other end of bottom wall 3a_1 on the vehicle width direction outer side and extends upward. The outer surface of one side wall 3a_2 in the vehicle width direction is fastened to the lower portion of bracket 5a with a fastener (bolt, nut). The outer surface of other side wall 3a_3 in the vehicle width direction is fastened to the lower portion of bracket 5a with a fastener (bolt, nut). As a result, cross member 3a is mounted between the pair of frames 2 via bracket 5a. Cross member 3a corresponds to the “first cross member” of the present disclosure.

Cross member 3b is disposed at a predetermined distance away from cross member 3a on the vehicle front side (−Y direction). Cross member 3b is formed to have the same cross-sectional shape as cross member 3a, and includes bottom wall 3b_1 that extends in the vehicle width direction (X direction), one side wall 3b_2 that is bent at one end of bottom wall 3b_1 on the vehicle width direction outer side and extends upward, and the other side wall 3b_3 that is bent at the other end of bottom wall 3b_1 on the vehicle width direction outer side and extends upward. The outer surface of one side wall 3b_2 in the vehicle width direction is fastened to the lower portion of bracket 5b with a fastener (bolt, nut). The outer surface of other side wall 3b_3 in the vehicle width direction is fastened to the lower portion of bracket 5b with a fastener (bolt, nut). As a result, cross member 3b is mounted between the pair of frames 2 via bracket 5b. Cross member 3b corresponds to the “first cross member” of the present disclosure.

Cross member 3d is disposed at a position in the upward direction (+Z direction) from a central position between a position in the vehicle front-rear direction (Y direction) at which cross member 3a is disposed and a position in the vehicle front-rear direction at which cross member 3b is disposed. Cross member 3d is a flat plate-shaped member having a substantially rectangular outer shape with the vehicle width direction (X direction) as its longitudinal direction. The outer end portion of cross member 3d in the vehicle width direction is fastened to the end portion of bracket 6 on the inner side in the vehicle width direction (−X direction) with a fastener (bolt, nut). Cross member 3d corresponds to the “second cross member” of the present disclosure.

As described above, cross member 3a, cross member 3b, bracket 5a, and bracket 5b are disposed at predetermined positions in the vehicle front-rear direction. Further, bracket 6 and cross member 3d are disposed at a predetermined position in the vehicle front-rear direction. As a result, double closed cross-sectional shapes are formed at predetermined positions in the vehicle front-rear direction. The first closed cross-sectional shape is formed by the pair of frames 2, cross member 3a, cross member 3d, bracket 5a, bracket 5b, and bracket 6. The second closed cross-sectional shape is formed by the pair of frames 2, cross member 3b, cross member 3d, bracket 5a, bracket 5b, and bracket 6.

As a result, at a predetermined position in the vehicle front-rear direction where battery BTR is disposed, for example, when a moment load around an axis extending in the vehicle front-rear direction (Y direction) acts on the pair of frames 2, a force in the opposite direction to the moment load is generated in cross member 3a and the like, which are components forming a closed cross-sectional shape, thereby reducing the deformation of frame 2. As a result, it is possible to increase the strength of the frame structure at a predetermined position in the vehicle front-rear direction. As a result, it is possible to prevent the supporting rigidity of the battery from decreasing.

Cross member 3c (see FIG. 2) is disposed at a predetermined distance away from the predetermined position in the vehicle front-rear direction toward the vehicle front side (−Y direction). Cross member 3c is formed in the same cross-sectional shape as cross member 3a, and includes bottom wall 3c_1, one side wall 3c_2, and the other side wall 3c_3. As a result, cross member 3c is mounted between the pair of frames 2.

Motor MTR (see FIG. 1) is disposed on cross member 3c. Motor MTR is disposed to be placed on bottom wall 3c_1. Cross member 3c corresponds to the “third cross member” of the present disclosure.

### (Mounting Table 8, Slide Mechanism 80, and the Like)

Next, mounting table 8, slide mechanism 80, and the like will be described with reference to FIGS. 3 and 4. Mounting table 8 is attached on frame 2 at a position on the vehicle width direction outer side (+X direction) via slide mechanism 80. As described above, two batteries BTR are attached on vehicle 1. Mounting table 8 and slide mechanism 80 and the like are also disposed corresponding to each of the two batteries BTR. In the following description, battery BTR, which is attached on frame 2 shown on the lower side in FIG. 3 from the vehicle width direction outer side, and mounting table 8 and slide mechanism 80, which are disposed corresponding to this battery BTR, will be mainly described.

Mounting table 8 is formed in a substantially inverted U-shaped cross-sectional shape, and includes top plate 8a that has a substantially rectangular plate surface facing upward (+Z direction), flange 8b that is bent at the vehicle rear side end of top plate 8a and extends downward (−Z direction), and flange 8c that is bent at the vehicle front side end of top plate 8a and extends downward (−Z direction). Battery BTR is placed on top plate 8a. Battery BTR includes a plurality of modules and the like and a box-shaped battery case BTRC housing the modules and the like. A striker (not illustrated) is provided at the bottom of battery case BTRC. WL latch 9 is disposed at the central portion of top plate 8a. WL latch 9 is capable of engaging with the striker to restrict the movement of battery BTR, which is placed on top plate 8a, in the upward direction (+Z direction), and is capable of disengaging from the striker to release the movement restriction of battery BTR in the upward direction (+Z direction).

Slide mechanism 80 includes guide rail 81a, guide rail 81b, slider 82a, and slider 82b. Guide rail 81a extends in the vehicle width direction (X direction). The end portion of guide rail 81a on the vehicle width direction inner side (−X direction) includes a flange that is bent and extends in the upward direction, and the flange is fastened to frame 2 via bracket 5a. Guide rail 81b is disposed on the vehicle front side (−Y direction) compared to guide rail 81a, and extends in the vehicle width direction (X direction). The end portion of guide rail 81b on the vehicle width direction inner side (−X direction) is bent and includes a flange that extends upward, and the flange is fastened to frame 2 via bracket 5b.

Slider 82a is disposed to be guidable in the vehicle width direction (X direction) by guide rail 81a. Flange 8b is fastened to slider 82a. Slider 82b is disposed to be guidable in the X direction by guide rail 81b. Flange 8c is fastened to slider 82b. As a result, battery BTR, which is placed on top plate 8a and whose movement in the upward direction (+Z direction) is restricted by WL latch 9, is integrated with slider 82a and slider 82b, and is guided in the vehicle width direction (X direction) by guide rail 81a and guide rail 81b.

### (Restraint Member 10)

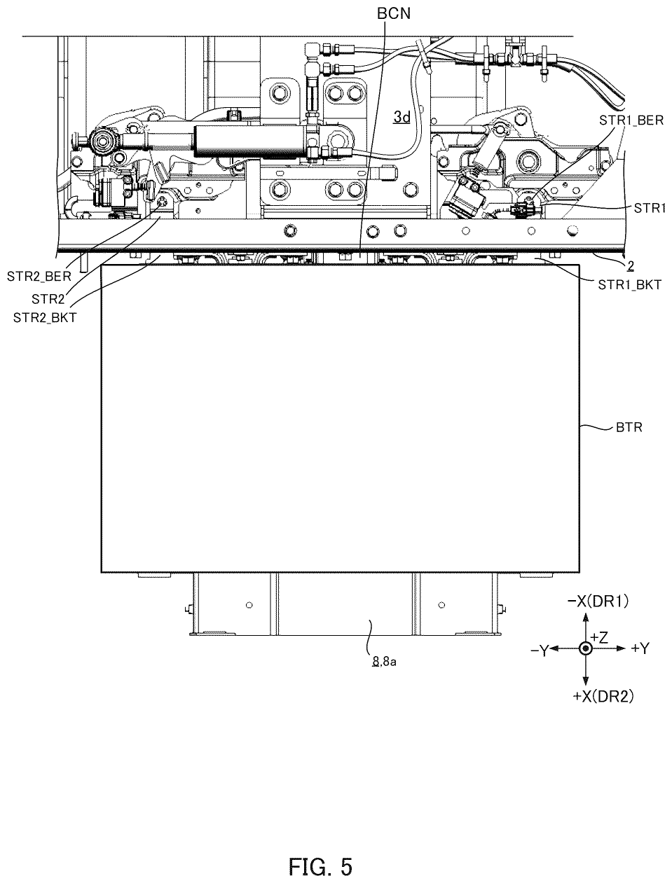

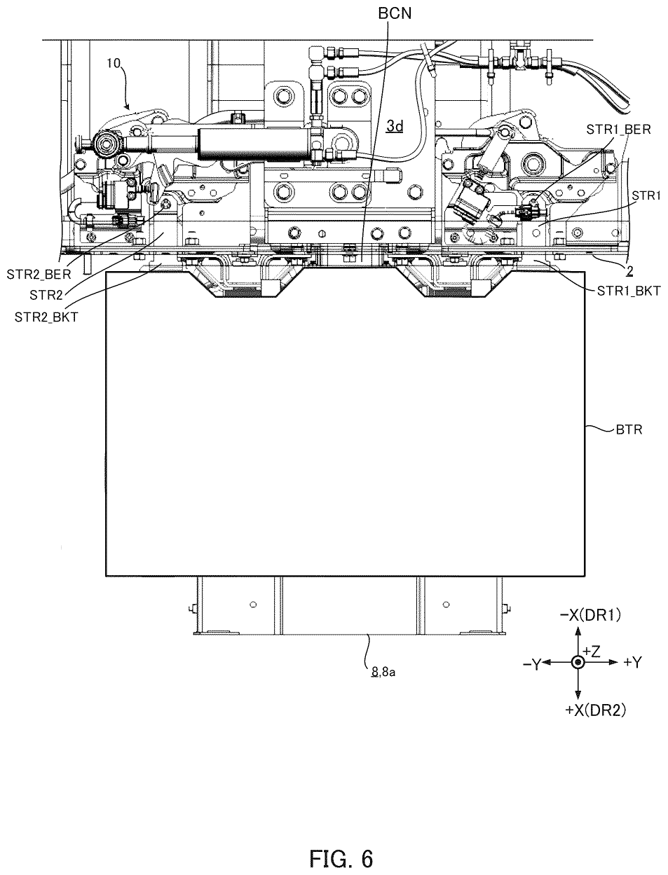

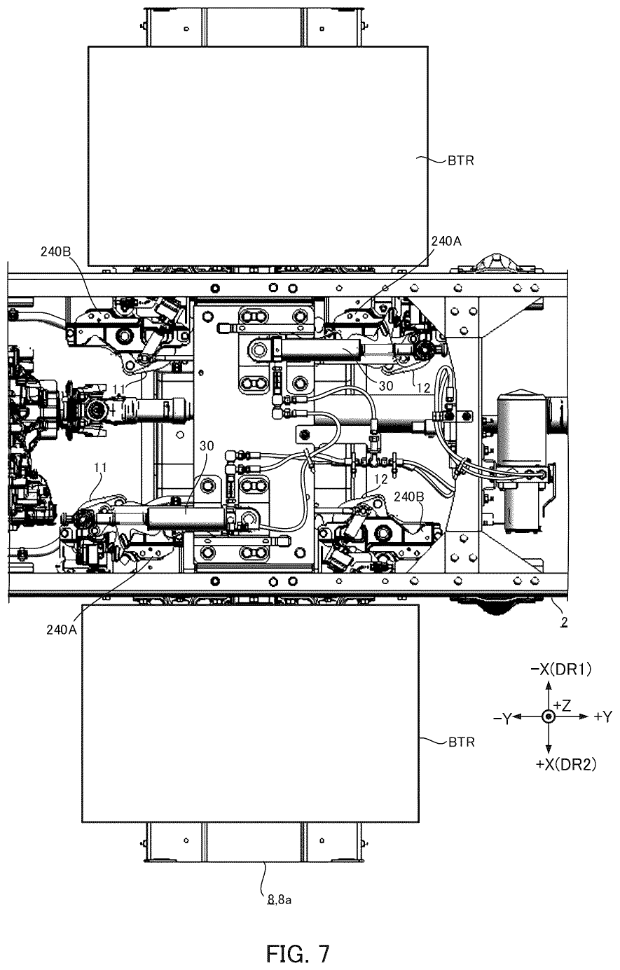

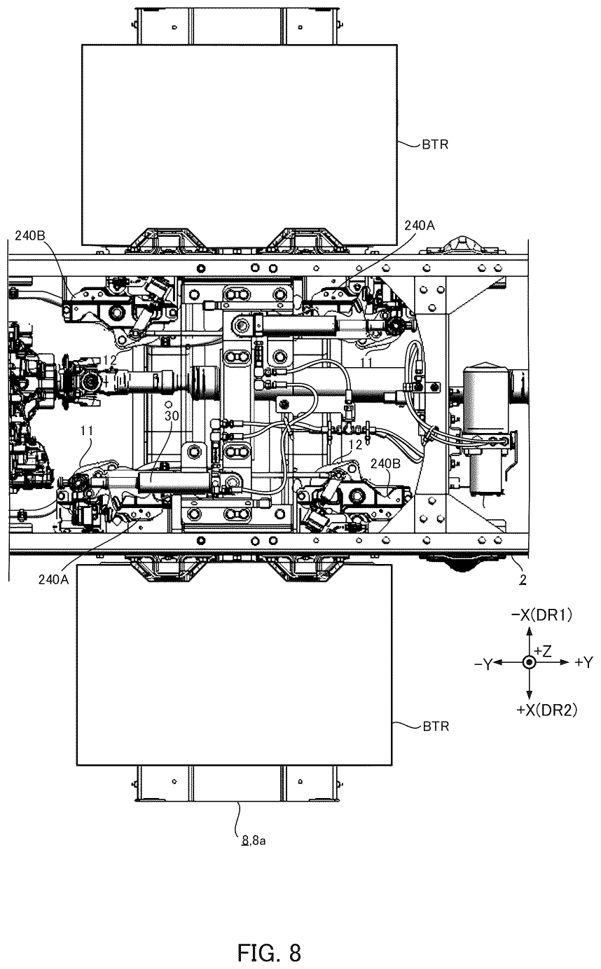

Next, restraint member 10, link mechanism 200, and the like will be described with reference to FIGS. 5, 6, 7, and 8. FIG. 5 is a plan view illustrating the battery support structure in the embodiment of the present disclosure. FIG. 6 is a plan view illustrating the battery support structure when the frame is seen through in the embodiment of the present disclosure. FIG. 7 is a plan view illustrating support structures for a pair of batteries in the embodiment of the present disclosure. FIG. 8 is a plan view illustrating the support structures for a pair of batteries when the frames are seen through in the embodiment of the present disclosure.

The pull-in (i.e., drawing) direction of battery BTR in the present disclosure is one direction DR1 along the horizontal plane. The pull-in direction of battery BTR in the present embodiment will be described as the vehicle width direction inner side (−X direction). One direction DR1 is not limited to this, and is set according to the disposition position of battery BTR. For example, when the position at which battery BTR is attached is a vehicle rear frame, the one direction DR1 may be a direction from the vehicle rear side to the vehicle front side.

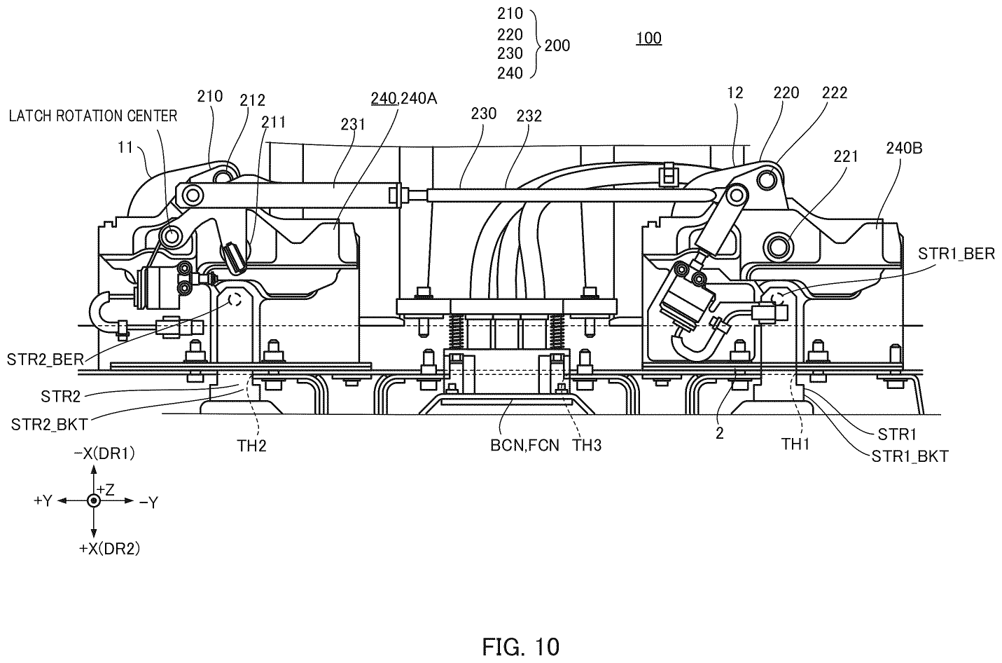

Battery BTR in the present embodiment is placed on top plate 8a with the side wall of the battery facing the vehicle width direction inner side (−X direction). Battery BTR is restrained in a state where battery BTR is drawn to frame 2 side. First striker STR1 is disposed on the side wall of battery BTR (the side wall drawn to restraint member 10). First striker STR1 includes the following: bracket STR1_BKT formed in a U-shaped cross-sectional shape and including an upper wall, a standing wall, and a lower wall; and striker bar STR1_BER formed in a rod shape and mounted between the upper wall and the lower wall. The standing wall of bracket STR1_BKT is fixed to the side wall of battery BTR so that the direction in which striker bar STR1_BER extends is directed in the up-down direction (Z direction). Frame 2 is provided with opened through-hole TH1 (see FIG. 10) through which first striker STR1 (the upper wall, the lower wall, and striker bar STR1_BER of bracket STR1_BKT) passes from the vehicle width direction outer side (+X direction) to the vehicle width direction inner side (−X direction) when battery BTR is drawn to the frame 2 side.

Second striker STR2 is disposed on the side wall of battery BTR at a predetermined distance from first striker STR1 in the vehicle front direction (−Y direction). Second striker STR2 includes bracket STR2_BKT having the same shape as bracket STR1_BKT and striker bar STR2_BER having the same shape as striker bar STR1_BER. Bracket STR2_BKT is fixed to the side wall of battery BTR so that the direction in which striker bar STR2_BER extends is directed in the up-down direction (Z direction). Frame 2 is provided with opened through-hole TH2 (see FIG. 10) through which second striker STR2 (the upper wall, the lower wall, and striker bar STR2_BER of bracket STR2_BKT) passes from the vehicle width direction outer side (+X direction) to the vehicle width direction inner side (−X direction) when battery BTR is drawn to the frame 2 side.

Battery connector BCN is disposed at a central position between the disposition position of first striker STR1 and the disposition position of second striker STR2 on the side wall of battery BTR. In a state where battery BTR is drawn to frame 2 and is restrained, battery connector BCN is electrically connected to vehicle-side connector FCN disposed on the frame 2 side. Further, frame 2 is provided with opened through-hole TH3 (see FIG. 10) through which battery connector BCN passes from the vehicle width direction outer side (+X direction) to the vehicle width direction inner side (−X direction) when battery BTR is drawn to frame 2 side.

Restraint member 10 is disposed on frame 2 side. Restraint member 10 restrains battery BTR in a state where battery BTR is drawn to the frame 2 side in such a way that, when battery BTR is drawn to the frame side (inner side in the vehicle width direction, −X direction, one direction DR1) with a predetermined force, battery BTR receives a reaction force against the predetermined force. Restraint member 10 includes first latch 11 and second latch 12. First latch 11 is configured to be capable of engaging with and disengaging from first striker STR1. In detail, first latch 11 is configured to be engageable with/detachable from striker bar STR1_BER of first striker STR1. Second latch 12 is configured to be engageable with/detachable from second striker STR2. Specifically, second latch 12 is configured to be engageable with/detachable from striker bar STR2_BER of second striker STR2. In the following description, first latch 11 being engaged with/detached from striker bar STR1_BER will be referred to as first latch 11 being engaged with/detached from first striker STR1. Similarly, second latch 12 being engaged with/detached from striker bar STR2_BER is referred to as second latch 12 being engaged with/detached from second striker STR2.

First latch 11 turns between an unlock position at which first latch 11 is detached from first striker STR1 and a lock position at which first latch 11 is engaged with first striker STR1, and further, is turnable between the lock position and a drawing position at which battery BTR is drawn toward vehicle 1 side via first striker STR1.

Second latch 12 turns between an unlock position at which second latch 12 is detached from second striker STR2 and a lock position at which second latch 12 is engaged with second striker STR2, and further, is turnable between the lock position and a drawing position at which battery BTR is drawn toward vehicle 1 side via second striker STR2.

### (Link Mechanism 200)

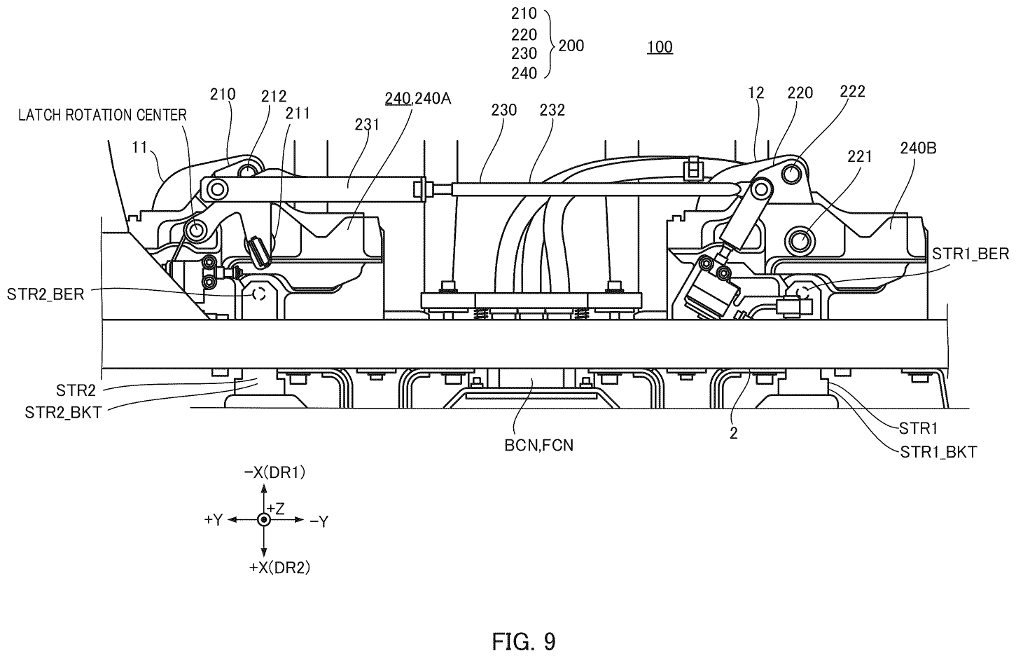

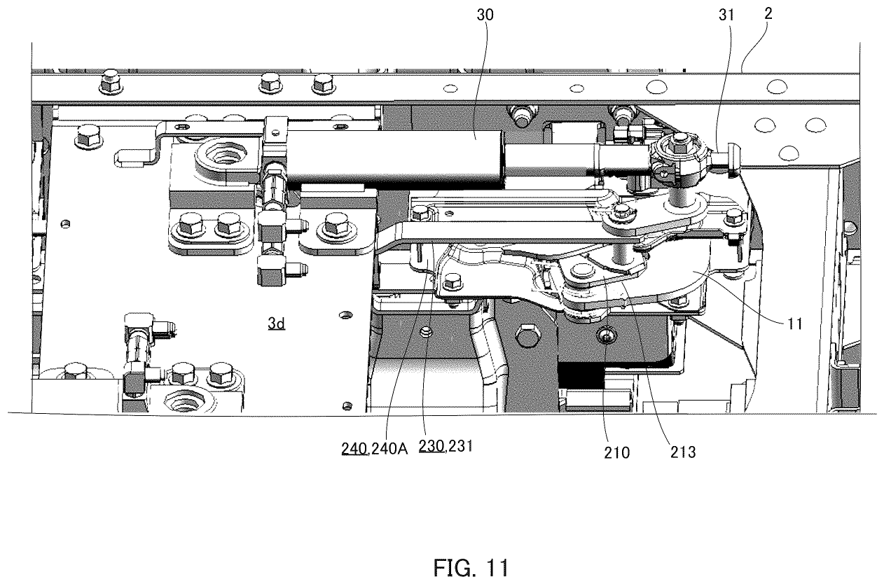

FIG. 9 is a plan view illustrating the restraint member and the like in the embodiment of the present disclosure. FIG. 10 is a plan view illustrating the restraint member and the like when the frame is seen through in the embodiment of the present disclosure. FIG. 11 is a perspective view illustrating the restraint member and the like in the embodiment of the present disclosure. Link mechanism 200 includes first link 210, second link 220, intermediate link 230, and fixed link 240. Link mechanism 200 in the present embodiment is a parallel link mechanism. That is, the distance from one end portion 211 of first link 210 in the length direction of the link (herein also referred to as “one end portion in the length direction 211”) to the other end portion 212 of first link 210 in the length direction of the link (herein also referred to as “other end portion in the length direction 212”) is equal to the distance from one end portion 221 of second link 220 in the length direction (herein also referred to as “one end portion in the length direction 221”) to the other end portion 222 of second link 220 in the length direction (herein also referred to as “other end portion in the length direction 222”). Further, the length of intermediate link 230 is equal to the distance between the position of one end portion in the length direction 211 of first link 210 and the position of one end portion in the length direction 221 of second link 220.

In the present embodiment, fixed link 240 is divided into fixed link 240A and fixed link 240B. Fixed link 240A is disposed on frame 2 so as to correspond to first latch 11. Further, fixed link 240B is disposed on frame 2 so as to correspond to second latch 12.

First link 210 is constituted by two members. The two members are integrated with each other. First link 210 is turnably coupled to fixed link 240A at one end portion in the length direction 211, and is turnably coupled to first latch 11 at the other end portion in the length direction 212.

Second link 220 is constituted by two members. The two members are integrated with each other. Second link 220 is turnably coupled to fixed link 240B at one end portion in the length direction 221, and is turnably coupled to second latch 12 at the other end portion in the length direction 222.

Intermediate link 230 includes link bracket 231 and link bar 232, and link bracket 231 and link bar 232 are coupled to each other such that the length of the link is adjustable. Intermediate link 230 couples intermediate portion 213 (see FIG. 11) in first link 210 (the intermediate portion located between one end portion in the length direction 211 and the other end portion in the length direction 212) with intermediate portion 213 in second link 220 (the intermediate portion located between one end portion in the length direction 221 and the other end portion in the length direction 222). The coupling position of intermediate link 230 is not limited to this, and for example, intermediate link 230 may couple other end portion in the length direction 212 of first link 210 with other end portion in the length direction 222 of second link 220.

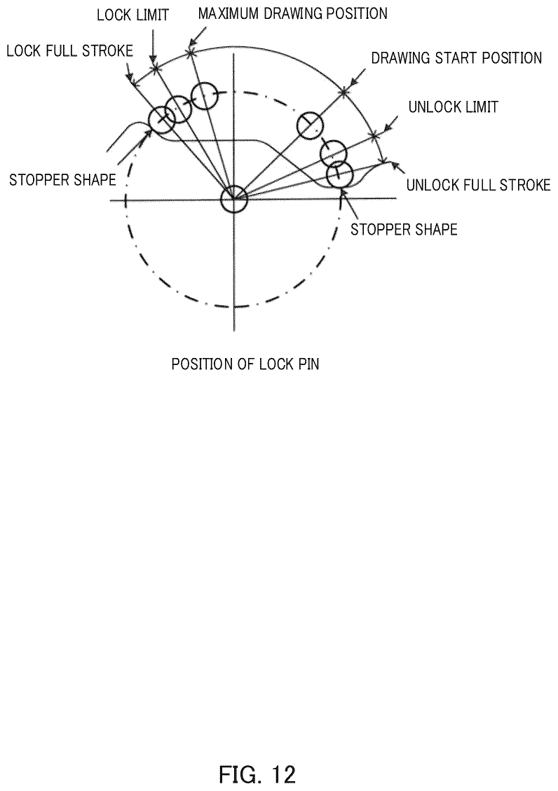

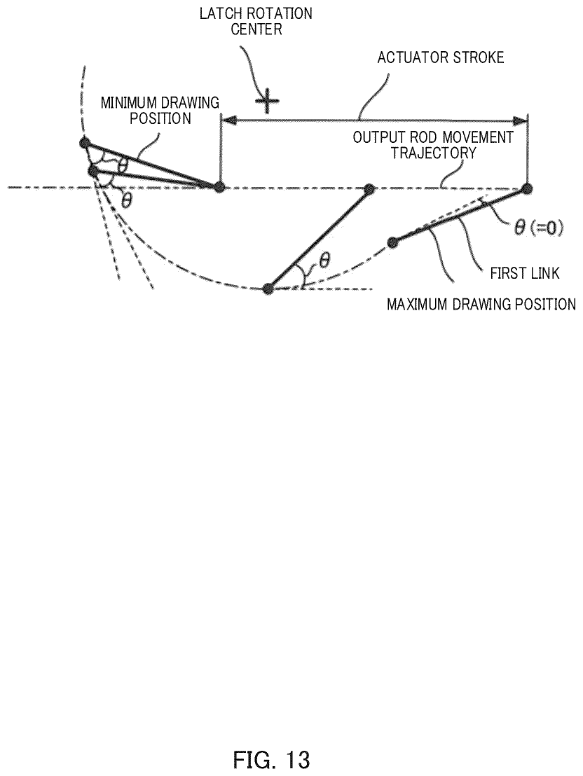

Next, the operations of first latch 11, second latch 12, and link mechanism 200 will be described with reference to FIGS. 12 and 13. In the following description, first latch 11 and second latch 12 are collectively referred to as “latches.” Further, first link 210 and second link 220 are collectively referred to as “links.”

### (Actuator 30)

Battery support structure 100 in the present embodiment includes a single actuator 30 that operates each of first latch 11 and second latch 12 via link mechanism 200. Actuator 30 includes output rod 31 (see FIG. 11). Actuator 30 in the present embodiment is a hydraulic cylinder. In the present embodiment, a part of the hydraulic circuit for driving actuator 30 is omitted. A link (not illustrated) that moves in conjunction with output rod 31 is turnably provided in fixed link 240, and lock pin PIN is fixed to the link. The movement of lock pin PIN is restricted/released by the stopper shape, thereby restricting the stroke of output rod 31.

Output rod 31 is coupled to first link 210. Output rod 31 may be coupled to second link 220. Output rod 31 is movable backward and forward along the direction in which intermediate link 230 extends. Further, output rod 31 is movable backward and forward in a direction orthogonal to the drawing direction in which battery BTR is drawn to vehicle 1.

FIG. 12 illustrates the relationship between the position of the latch and the position of the lock pin. In FIG. 12, lock pin PIN is illustrated with a one-dot chain line, and the stopper shape for restricting/releasing the movement of lock pin PIN is illustrated with a solid line. In FIG. 12, the drawing direction of battery BTR is indicated in a counterclockwise direction, and the pull-back direction of battery BTR is indicated in a clockwise direction. At the unlock full stroke, which is a position where the latch is turned by a predetermined angle clockwise from the unlock limit, lock pin PIN abuts against the stopper shape. As a result, the stroke of output rod 31 is limited. The drawing start position is set at a position where the latch is turned by a predetermined angle in the counterclockwise direction from the unlock limit. The maximum drawing position is set at a position where the latch turns counterclockwise by a predetermined angle from the drawing start position. The lock limit is set at a position where the latch is movable by a predetermined angle in the counterclockwise direction from the maximum drawing position. In the lock full stroke, which is a position where the latch is turned by a predetermined angle counterclockwise from the lock limit, lock pin PIN abuts against the stopper shape. As a result, the stroke of output rod 31 is limited.

FIG. 13 illustrates the relationship between the position of the output rod and the position of the link. As described above, link mechanism 200 in the present embodiment is a parallel link mechanism, and first link 210 and second link 220 perform the same movement as each other. FIG. 13 illustrates first link 210 as a representative link in link mechanism 200 in solid lines, and also illustrates one end portion in the length direction 211 and the other end portion in the length direction 212 of first link 210 in solid black circles. In FIG. 13, an arc, which is a trajectory of a position of other end portion in the length direction 212 of first link 210, is illustrated with a one-dot chain line, a tangent line at each position of the other end portion in the arc is illustrated with a broken line, and an angle θ of first link 210 in the length direction with respect to the direction of the tangent line at each position of the other end portion is illustrated.

When first latch 11 turns between the unlock position and the lock position, the length direction of first link 210 forms an acute angle with a direction of a tangent line passing through a position of other end portion in the length direction 212 of first link 210 (the position on a circumference concentric with the turning center of first latch 11). That is, in a region between the unlock position and the lock position, angle θ of first link 210 in the length direction with respect to the direction of the tangent line changes within a range of an acute angle (0°<θ<90°). As a result, first link 210 can transmit from actuator 30 to first latch 11 the force in the direction necessary for first latch 11 to turn between the unlock position and the lock position, can reliably transmit the force to the first latch, and can allow the first latch to turn smoothly, thereby making it possible to avoid, for example, the occurrence of a deadlock.

Further, when second latch 12 turns between the unlock position and the lock position, the length direction of second link 220 forms an acute angle with a direction of a tangent line passing through a position of other end portion in the length direction 222 of second link 220 (the position on a circumference concentric with the turning center of second latch 12). That is, in the same manner as first latch 11, angle θ of first link 210 in the length direction with respect to the direction of the tangent line changes within the range of an acute angle (0°<θ<90°) between the unlock position and the lock position. As a result, second link 220 can transmit the force in the direction necessary to turn second latch 12 between the unlock position and the lock position from actuator 30 to second latch 12. Therefore, second latch 12 can turn smoothly in the same manner as first latch 11.

When first latch 11 turns to the drawing position (the maximum drawing position illustrated in FIG. 13), the length direction of first link 210 is substantially parallel to the direction of a tangent line passing through the position of other end portion in the length direction 212 of first link 210 on the circumference. In FIG. 13, the state in which the length direction of second link 220 and the direction of the tangent line are parallel to each other is indicated by “θ(=0).” Similarly, when second latch 12 turns to the drawing position (a position corresponding to the maximum drawing position illustrated in FIG. 13), the length direction of second link 220 is substantially parallel to the direction of a tangent line passing through the position of other end portion in the length direction 222 of second link 220 on the circumference. The allowable tolerance of the parallelism in the length direction with respect to the direction of the tangent line is set, for example, according to the driving force of actuator 30, the set axial force of a bolt that fixes each of first latch 11, second latch 12, and actuator 30, and the like.

As a result, first link 210 can efficiently transmit to first latch 11 the force for turning first latch 11, and second link 220 can efficiently transmit to second latch 12 the force for turning second latch 12, making it possible to efficiently operate each of first latch 11 and second latch 12 and to draw battery BTR toward vehicle 1 side with sufficient force.

With the above configuration, battery BTR is supported on frame 2 side in a state where battery BTR is drawn in one direction DR1 (vehicle width direction inner side) along the horizontal plane. As a result, even when vehicle vibration causes battery case BTRC to move with respect to frame 2, the frictional resistance between battery case BTRC and frame 2 is generated, and it is possible to suppress the rattling of battery BTR in the vehicle front-rear direction. It should be noted that, it may be difficult to prevent battery BTR from rattling in the vehicle front-rear direction only with the friction resistance between battery case BTRC and frame 2.

### (Elastic Body 300, First Elastic Body 300A, Second Elastic Body 300B, Elastic Body Set 300S)

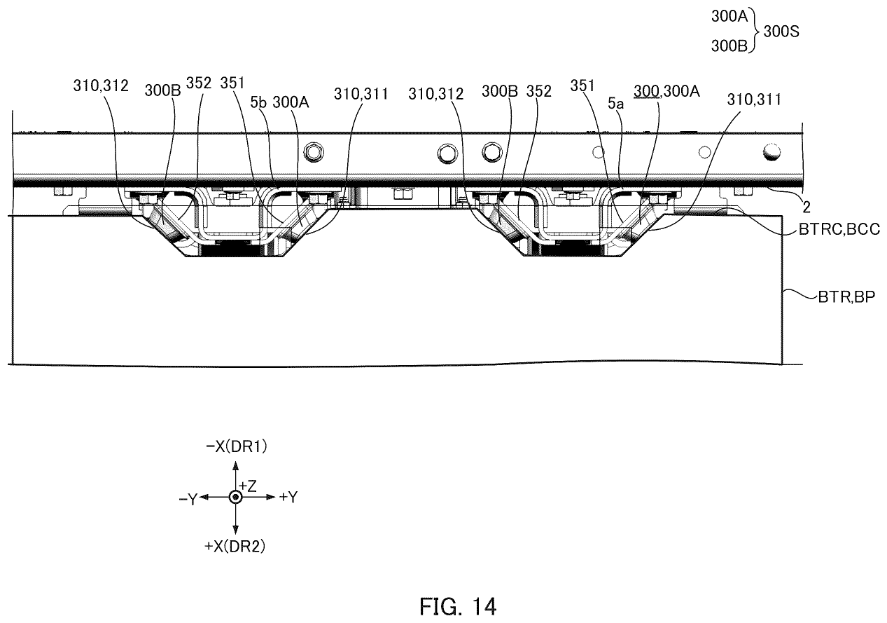

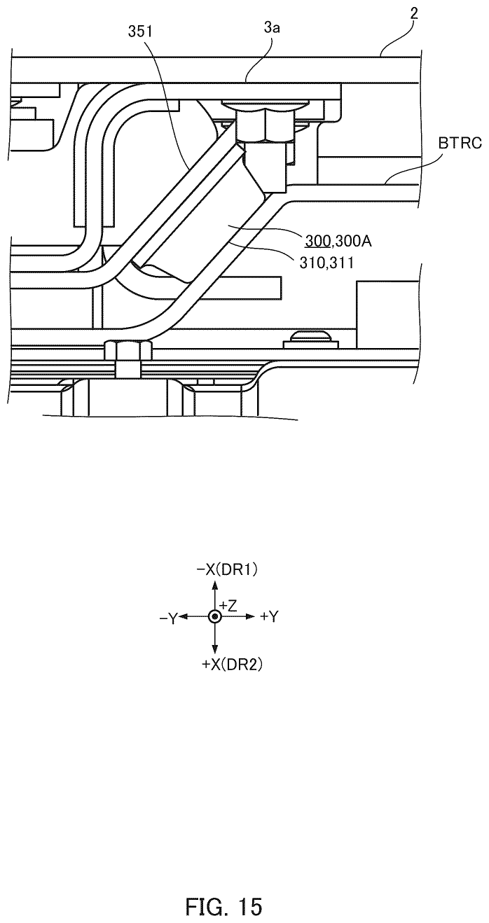

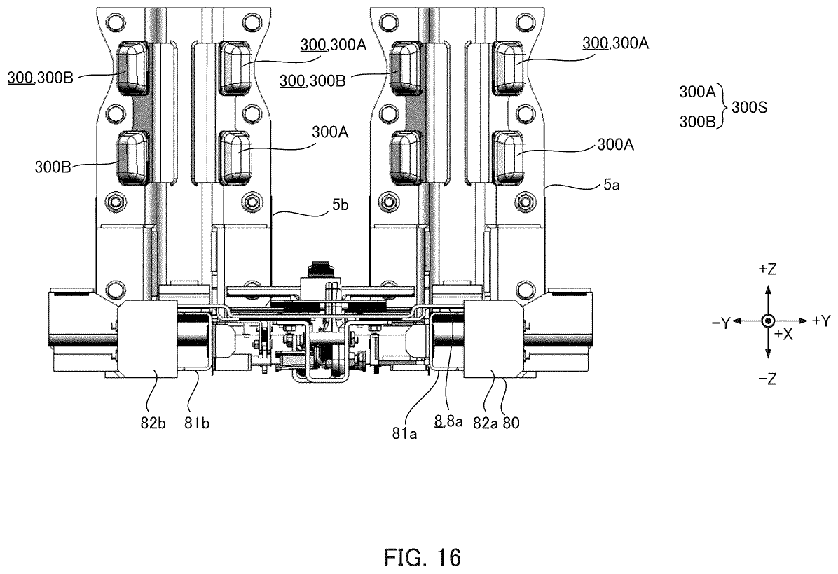

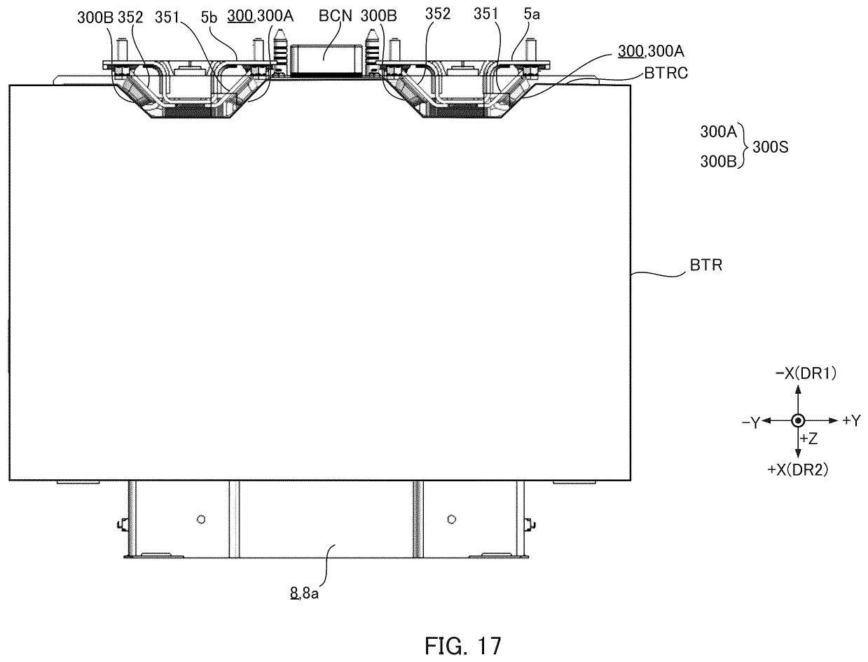

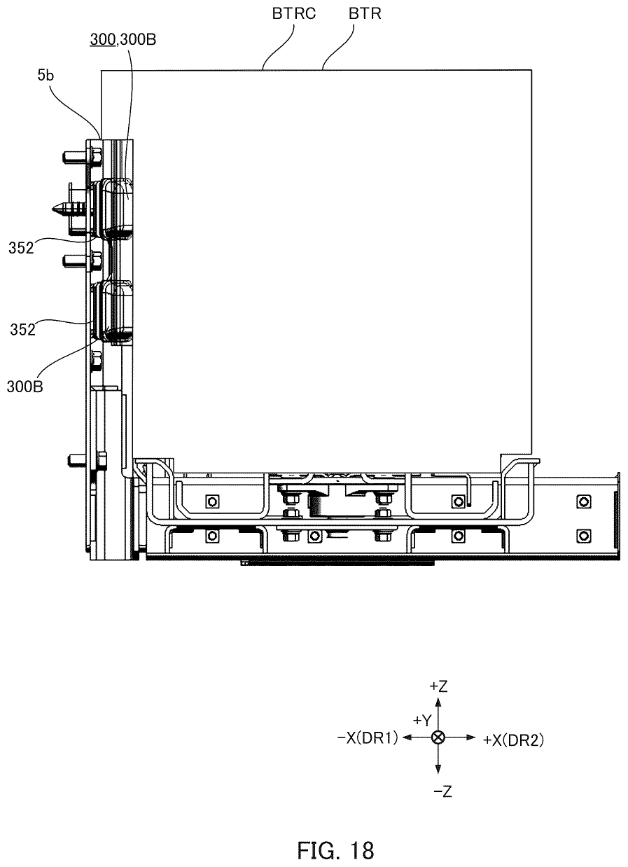

Next, elastic body 300 and the like will be described with reference to FIGS. 14 to 18. FIG. 14 is a plan view illustrating the battery support structure in an embodiment of the present disclosure. FIG. 15 is a plan view illustrating an elastic member and the like in the embodiment of the present disclosure. FIG. 16 is a side view illustrating the battery support structure in the embodiment of the present disclosure. FIG. 17 is a plan view illustrating the battery support structure when the frame is seen through in the embodiment of the present disclosure. FIG. 18 is a front view of the battery support structure in the embodiment of the present disclosure as seen from the front side of the vehicle.

Elastic body 300 is a plate-shaped elastic body including plate surface 310 (see FIGS. 14 and 15) constituted by a flat plate-shaped surface. Elastic body 300 is disposed at a position corresponding to each of bracket 5a and bracket 5b. Hereinafter, elastic body 300 disposed at bracket 5a will be representatively described, and elastic body 300 disposed at bracket 5b will be described mainly in terms of differences from elastic body 300 disposed at bracket 5a. Further, elastic body 300 disposed at first bracket 351 is used as first elastic body 300A. Alternatively, elastic body 300 disposed at second bracket 352 is used as second elastic body 300B. First bracket 351 and second bracket 352 are metal plates. Each of both end portions of the plate is welded to bracket 5a. In the present embodiment, first elastic body 300A and second elastic body 300B are used in combination with each other. Hereinafter, a combination of first elastic body 300A and second elastic body 300B may be referred to as an “elastic body set.” Two elastic body sets 300S are disposed at bracket 5a to be separated from each other in the up-down direction.

First elastic body 300A is disposed so that plate surface 310 becomes first elastic surface 311 (see FIGS. 14 and 15) that is inclined toward one side in the orthogonal direction (in the present embodiment, the vehicle rear side) along the horizontal plane with respect to other direction DR2 (the vehicle width direction outer side in FIG. 14) that is opposite to one direction DR1 (the vehicle width direction inner side in the present embodiment). Further, the inclination angle at which first elastic surface 311 is inclined toward the one side in the orthogonal direction with respect to other direction DR2 is set according to the weight, size, and the like of battery BTR. First elastic body 300A is disposed on the frame 2 side via first bracket 351 and bracket 5a so that plate surface 310 constitutes first elastic surface 311. Bracket 5a is formed such that the horizontal cross section thereof has a hat channel shape. The end portion of the bracket on the vehicle rear side (+Y direction) and an end portion of the bracket on the vehicle front side (−Y direction) are located on the vehicle width direction inner side (−X direction) compared to the central portion of the bracket in the vehicle front-rear direction (Y direction). Specifically, plate surface 310 constitutes first elastic surface 311 by being spanned between the end portion on the vehicle rear side and the central portion in the vehicle front-rear direction.

When battery BTR is drawn in one direction DR1, first elastic surface 311 is sandwiched between the battery case BTRC side and the frame 2 side (first bracket 351 side) thus compressed and deformed, and a restoring force against the compressed deformation is generated. As a result, one component in the direction in which first elastic surface 311 is restored becomes other direction DR2 (in the present embodiment, the vehicle width direction outer side). Further, another component in the direction in which first elastic surface 311 is restored becomes one side in the direction orthogonal to other direction DR2 (in the present embodiment, the vehicle rear side). On the other hand, battery case BTRC includes an inclined surface that is inclined along first elastic surface 311. As a result, battery case BTRC is pushed back in the other direction DR2 and is also pushed back toward the vehicle rear side by the restoring force of first elastic surface 311.

Second elastic surface 312 is disposed on the vehicle front side (−Y direction) compared to first elastic surface 311. In other words, first elastic surface 311 and second elastic surface 312 are disposed to be separated from each other in the vehicle front-rear direction (Y direction).

Second elastic body 300B is disposed so that plate surface 310 becomes second elastic surface 312 that is inclined toward the other side in the orthogonal direction (vehicle front side in the present embodiment) along the horizontal plane with respect to one direction DR1 and the other direction DR2 (vehicle width direction outer side). Further, the inclination angle at which second elastic surface 312 is inclined toward the other side in the orthogonal direction with respect to other direction DR2 is set according to the weight, size, and the like of battery BTR. Second elastic body 300B is disposed on the frame 2 side via second bracket 352 and bracket 5a so that plate surface 310 constitutes second elastic surface 312 (see FIG. 14). Specifically, plate surface 310 constitutes second elastic surface 312 by being spanned between the end portion of bracket 5 on the vehicle front side and the central portion in the vehicle front-rear direction.

When battery BTR is drawn in one direction DR1, Second elastic surface 312 is sandwiched between battery case BTRC side and frame 2 side (second bracket 352 side) and thus compressed and deformed, and a restoring force against the compressed deformation is generated. As a result, one component in the direction in which second elastic surface 312 is restored becomes other direction DR2 (vehicle width direction outer side). Further, another component in the direction in which second elastic surface 312 is restored becomes one side in the orthogonal direction (vehicle front side) along the horizontal plane with respect to other direction DR2. On the other hand, battery case BTRC includes an inclined surface that is inclined along second elastic surface 312. As a result, battery case BTRC is pushed back in the other direction DR2 and is also pushed back toward the vehicle front side by the restoring force of second elastic surface 312. The force with which battery case BTRC is pushed back toward the vehicle rear side by the restoring force of first elastic surface 311 is balanced with the force with which battery case BTRC is pushed back toward the vehicle front side by the restoring force of second elastic surface 312.

With the above configuration, in a case where battery BTR is supported on frame 2 side in a state of battery BTR being drawn in one direction DR1 (vehicle width direction inner side), even when vehicle vibration causes battery case BTRC to move in the vehicle width direction (X direction) with respect to frame 2, it is possible to suppress rattling of battery BTR in the vehicle width direction (X direction) from the following reasons: battery BTR is supported in a state in which the reaction force in other direction DR2 due to the restoring force of first elastic surface 311 and the drawing force in one direction DR1 are balanced, and battery BTR is supported in a state in which the reaction force in other direction DR2 due to the restoring force of second elastic surface 312 and the drawing force in one direction DR1 are balanced. Further, even when vehicle vibration causes battery case BTRC to move in the vehicle front-rear direction (Y direction) with respect to frame 2, it is possible to suppress rattling of battery BTR in the vehicle front-rear direction (Y direction) because battery BTR is supported in a state of being balanced in the vehicle front-rear direction (Y direction) by the respective restoring forces of first elastic surface 311 and second elastic surface 312.

Elastic body 300A disposed in first bracket 351 has been described. Elastic body 300B disposed in second bracket 352 is the same as elastic body 300A. That is, even when vehicle vibration causes battery case BTRC to move in the vehicle width direction (X direction) with respect to frame 2, it is possible to suppress rattling of battery BTR in the vehicle width direction (X direction) from the following reasons: battery BTR is supported in a state in which the reaction force in other direction DR2 due to the restoring force of first elastic surface 311 and the drawing force in one direction DR1 are balanced, and battery BTR is supported in a state in which the reaction force in other direction DR2 due to the restoring force of second elastic surface 312 and the drawing force in one direction DR1 are balanced. Further, even when vehicle vibration causes battery case BTRC to move in the vehicle front-rear direction (Y direction) with respect to frame 2, it is possible to suppress rattling of battery BTR in the vehicle front-rear direction (Y direction) because battery BTR is supported in a state of being balanced in the vehicle front-rear direction (Y direction) by the respective restoring forces of first elastic surface 311 and second elastic surface 312.

As described above, providing elastic body 300A and elastic body 300B can prevent battery BTR from rattling in the vehicle width direction (X direction). Further, it is possible to prevent battery BTR from rattling in the vehicle front-rear direction (Y direction). Further, as described above, battery BTR placed on top plate 8a is restricted from moving in the upward direction (+Z direction) by WL latch 9, and thus, it is possible to prevent battery BTR from rattling in the up-down direction (Z direction).

Further, elastic body set 300S in which elastic body 300A and elastic body 300B are combined with each other is also disposed at bracket 5b. Two elastic body sets 300S are disposed vertically spaced apart at bracket 5b. As a result, when battery BTR is drawn in one direction DR1 (frame 2 side), battery BTR unevenly receives a reaction force to the drawing force in the vehicle front-rear direction (Y direction), and thus, battery BTR does not receive, for example, a moment load around the vehicle front side end portion or a moment load around the vehicle rear side end portion, thereby stably attaching battery BTR on the frame 2 side. From this point, it is also possible to suppress rattling of battery BTR due to vehicle vibration.

Further, elastic body sets 300S are disposed at both end portions of the side wall of battery BTR in the vehicle front-rear direction, and battery connector BCN is disposed at the central position of the side wall of battery BTR in the vehicle front-rear direction. At the central position of the side wall of battery BTR in the vehicle front-rear direction, it is possible to sufficiently prevent battery BTR from rattling due to vehicle vibration. As a result, it is possible to maintain the electrical connection state with vehicle-side connector FCN.

### (Battery Unit BTR)

Next, the battery unit will be described. In the following description, the battery unit may be simply referred to as “battery” and may be represented by battery BTR or battery unit BTR.

Battery unit BTR includes battery pack BP, battery case BTRC, battery cover BCVR, and battery connector BCN. Battery pack BP includes a plurality of battery modules (not illustrated), an electric power harness (not illustrated), a battery management section (not illustrated), and a junction box (not illustrated).

### (Battery Case BTRC)

Battery case BTRC includes accommodation section BCC for accommodating battery pack BP. Accommodation section BCC has a predetermined length in each of the short direction, the long direction, and the height direction in accordance with the rectangular parallelepiped outer shape of battery pack BP. In the present embodiment, battery BTR is supported on vehicle 1 side such that the short direction of the battery is the vehicle width direction (X direction), the long direction of the battery is the vehicle front-rear direction (Y direction), and the height direction of the battery is the vehicle height direction. In the following description, the short direction is referred to as the X direction, one side in the short direction is referred to as the “+X direction,” and the other side in the short direction is referred to as the “−X direction.” Further, the longitudinal direction is referred to as the Y direction, one side in the longitudinal direction is referred to as the “+Y direction,” and the other side in the longitudinal direction is referred to as the “−Y direction.” Further, the height direction is referred to as the Z direction, the upward direction is referred to as the upper side or the “+Z direction,” and the downward direction is referred to as the lower side or the “−Z direction.”

Battery case BTRC includes bottom wall section BWL on which battery pack BP is placed, and both side wall sections SWL. One of the both side wall sections SWL is a side wall section that is erected upward (+Z direction) from the end portion of bottom wall section BWL on the one side in the longitudinal direction. The other one of the both side wall sections SWL is a side wall section that is erected upward (+Z direction) from the end portion of bottom wall section BWL on the other side in the longitudinal direction. Accommodation section BCC is open in the directions of one side in the short direction (+X direction), the other side in the short direction (−X direction), and the upward direction (+Z direction).

### (Battery Cover BCVR)

Battery cover BCVR includes one side wall section WL1 in the short-side direction, other side wall section WL2 in the short-side direction, and upper side wall section WL3. When battery cover BCVR is assembled to battery case BTRC, accommodation section BCC (battery pack BP) is in a state of being covered from the directions of one side in the short direction (+X direction), the other side in the short direction (−X direction), and the upper side (+Z direction). The other side wall section WL2 in the short-side direction corresponds to the “standing wall” in the present disclosure. In the following description, other side wall section WL2 in the short-side direction will be described as standing wall 50.

Standing wall 50 (other side wall section WL2 in the short-side direction) includes front surface 51 that faces the other side in the short direction (−X direction) and back surface 52 that faces the one side in the short direction (+X direction). Standing wall 50 includes through-hole 54. Through-hole 54 is a hole that extends from front surface 51 side to back surface 52 side in the short direction (X direction). Battery connector BCN is disposed on front surface 51 side. Further, battery pack BP is disposed on back surface 52 side.

### (Battery Connector BCN)

Battery connector BCN is a connector that connects a bus bar (not illustrated) that is a conductor. Battery connector BCN is electrically connected to a battery module (not illustrated) via the bus bar, an electric power harness (not illustrated), and a junction box (not illustrated).

Battery connector BCN includes main body 60 made of resin. Main body 60 has a rectangular outer shape. Each of the four corner portions of main body 60 is provided with pilot hole 61 that extends in the short direction (X direction). Groove 62 into which seal section 75 (described below) is fitted is disposed on the back side of main body 60 facing standing wall 50.

When battery unit BTR is supported in a state of battery BTR being drawn toward vehicle 1 side, battery connector BCN is electrically connected to vehicle-side connector FCN (see FIG. 9) fixed to frame 2. Vehicle-side connector FCN is electrically connected to motor MTR side via an electric power harness (not illustrated).

### (Assembly Structure 400 of Battery Connector)

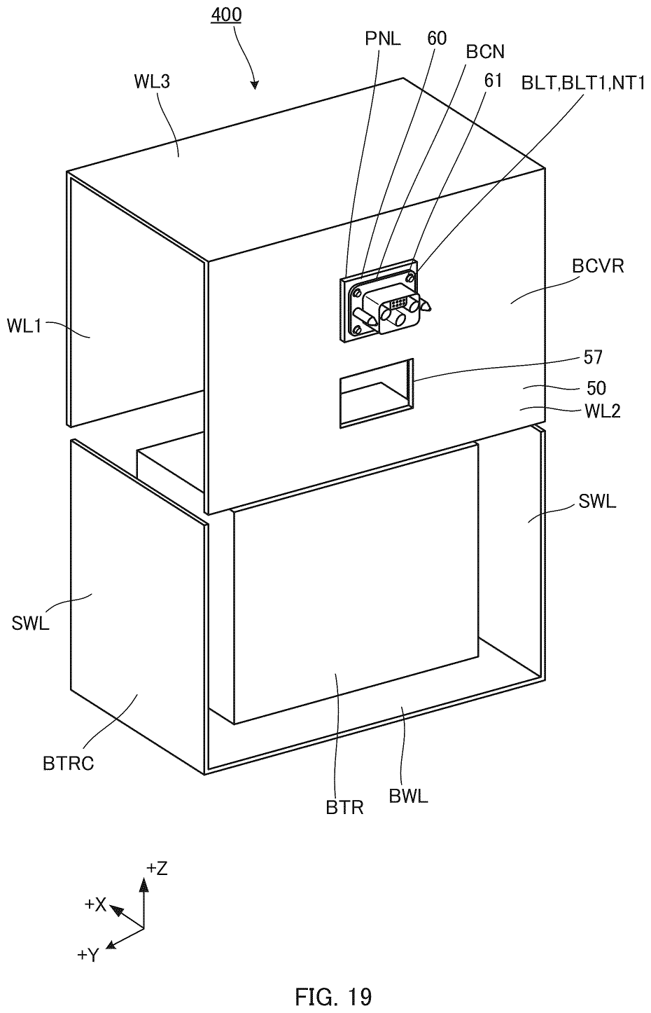

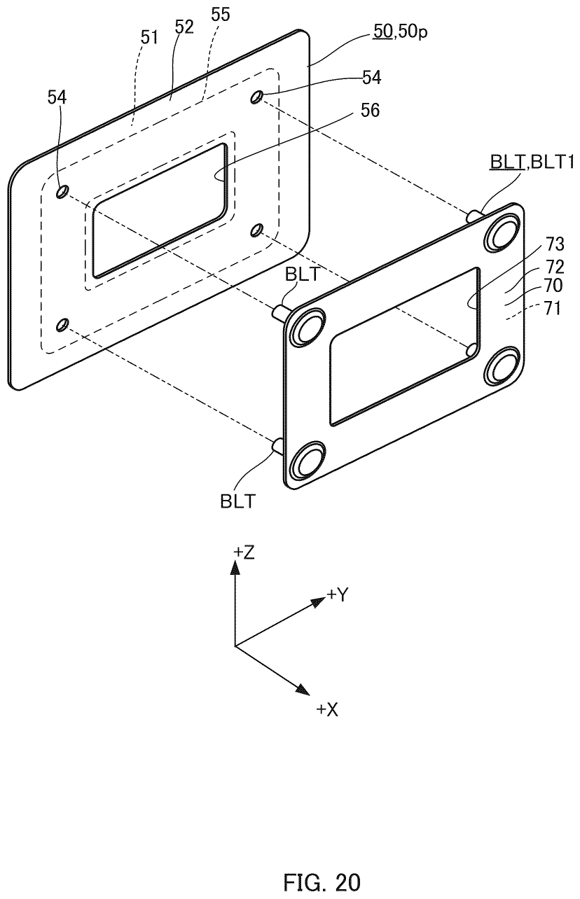

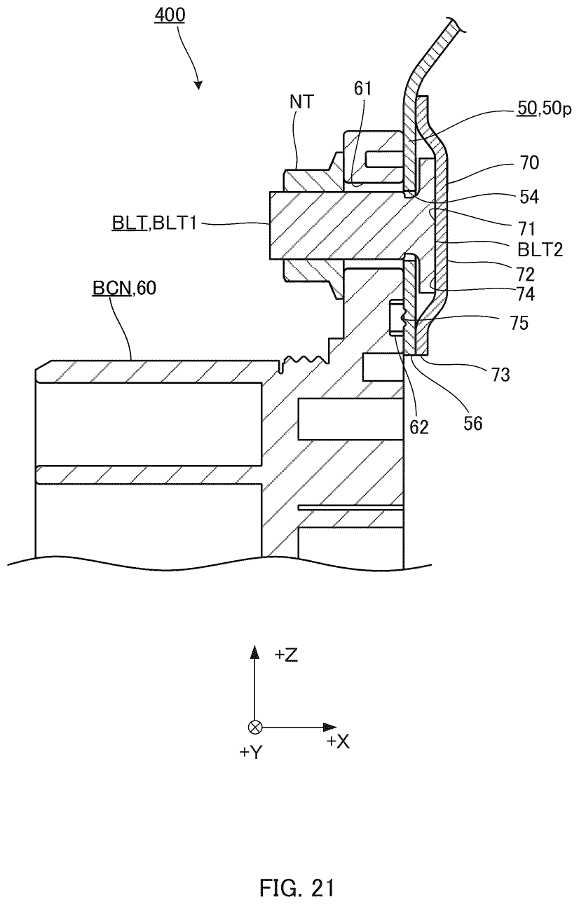

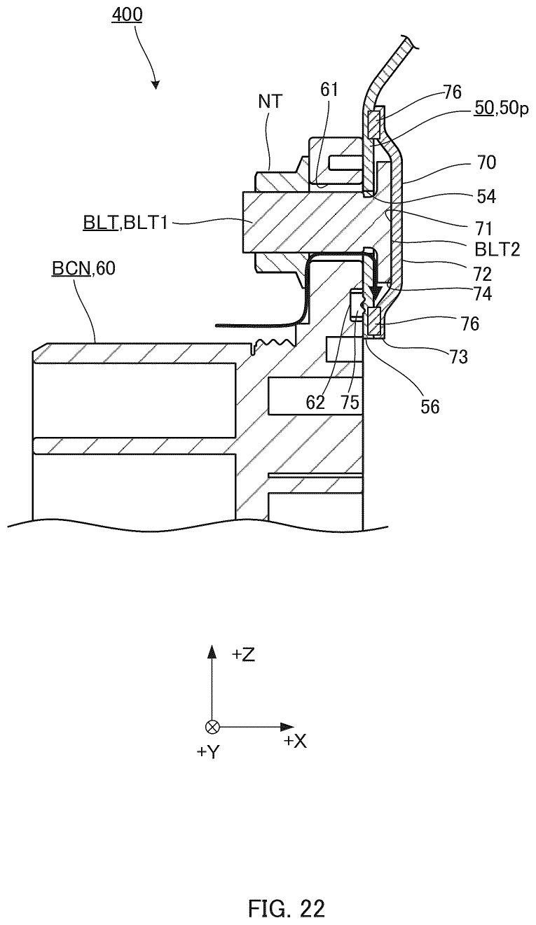

Next, assembly structure 400 of a battery connector will be described with reference to FIGS. 19, 20, 21, and 22. FIG. 19 is a perspective view of the assembly structure of a battery connector in the embodiment of the present disclosure as viewed from the other side in the oblique short direction. FIG. 20 is a partially exploded perspective view of a part of the assembly structure of the battery connector in the embodiment of the present disclosure as viewed from one side in the oblique short direction. FIG. 21 is a partial cross-sectional view partially illustrating a cross section of the assembly structure of the battery connector in the embodiment of the present disclosure along the up-down direction. FIG. 22 illustrates movement of moisture drawn on a partial cross-sectional view partially representing a cross section along the up-down direction of the assembly structure of the battery connector in an embodiment of the present disclosure. FIGS. 20, 21, and 22 illustrate panel 50p as a part of standing wall 50. Further, FIG. 22 illustrates the movement of water with an arrow of a thick solid line.

In the present embodiment, through-holes 54 are disposed in panel 50p. Further, opening section 56 for wiring is provided to be opened in panel 50p, and opening section 57 for working is provided to be opened on the lower side (−Z direction) compared to opening section 56 for wiring.

Battery connector BCN is disposed at battery cover BCVR. Specifically, battery connector BCN is disposed on standing wall 50 so as to correspond to the position of opening section 56 for wiring. When battery connector BCN is disposed as described above, pilot holes 61 disposed at the four corner portions of main body 60 respectively correspond to the positions of through-holes 54.

### (Fastener BLT, Plate 70)

For the assembly of battery connector BCN, fasteners BLT and plate 70 are used. Plate 70 includes plate front surface 71 (the “outer surface” of the present disclosure), plate back surface 72 (the “inner surface” of the present disclosure), and opening section 73 for wiring. Plate front surface 71 is disposed to face back surface 52. Plate front surface 71 includes recess section 74. Recess portion 74 is recessed from plate front surface 71 side to plate back surface 72 side by a dimension corresponding to the thickness of head portion BLT2 (see FIGS. 21 and 22) of fastener BLT. As a result, head portion BLT2 does not protrude from plate front surface 71 to back surface 52 side (the “inner side” in the present disclosure). Opening section 73 for wiring is disposed at a position corresponding to the position of opening section 56 for wiring.

Plate front surface 71 is disposed to face back surface 52. Liquid gasket 76 as a waterproof section is disposed in predetermined region 55 so as to fill a gap between plate front surface 71 and back surface 52. Predetermined region 55 includes an inner peripheral edge and an outer peripheral edge, and four through-holes 54 are disposed in a region between the inner peripheral edge and the outer peripheral edge. In other words, liquid gasket 76 is disposed in predetermined region 55 so as to surround four through-holes 54 collectively. FIG. 20 illustrates predetermined region 55 in which liquid gasket 76 is disposed.

Fastener BLT is, for example, a bolt, and includes screw portion BLT1 and head portion BLT2. Screw portion BLT1 passes through through-hole 54 and pilot hole 61 from back surface 52 side to front surface 51 side (the “outer side” in the present disclosure). As described above, head portion BLT2 is fitted into recess section 74 and is welded to plate front surface 71.

### (Assembly Method of Battery Connector BCN)

Next, an assembly method of battery connector BCN in the embodiment of the present disclosure will be described. Liquid gasket 76 (waterproof section) is applied in advance to predetermined region 55 of back surface 52. Further, seal section 75 is fitted into groove 62 of main body 60.

First, main body 60 of battery connector BCN is disposed so that pilot holes 61 correspond to through-holes 54 in standing wall 50 (panel 50p).

Next, plate 70 is disposed so that screw portion BLT1 passes through pilot hole 61 and through-hole 54, and plate front surface 71 is in close contact with back surface 52. As a result, screw portion BLT1 protrudes to front surface 51 side, and liquid gasket 76 (waterproof section) is disposed in the gap between plate front surface 71 and back surface 52.

Next, nut NT is screwed onto screw portion BLT1 protruding to front surface 51 side, and battery connector BCN is fastened to standing wall 50 (panel 50p) by nut NT.

Assembly structure 400 of the battery connector in the above embodiment includes the following: standing wall 50 (panel 50p) that includes front surface 51 and back surface 52, where battery pack BP is disposed on the back surface 52 side, and the standing wall is provided with opened through-holes 54 each extending in the horizontal direction from the front surface 51 side to the back surface 52 side; battery connector BCN that includes pilot holes 61 extending in the horizontal direction and disposed so that pilot holes 61 respectively correspond to through-holes 54; fasteners BLT each including screw portion 41 and head portion 42; and plate 70 that includes plate front surface 71 disposed to face back surface 52 with head portion BLT2 fixed to plate front surface 71. In the assembly structure of the battery connector, battery connector BCN is fastened to front surface 51 side by fasteners BLT each including screw portion BLT1 passing through through-hole 54 and pilot hole 61 from back surface 52 side to front surface 51 side, and the assembly structure includes liquid gasket 76 disposed to surround through-holes 54 on the plate front surface 71 side.

According to the above configuration, moisture such as rainwater that adheres to front surface 51 side of standing wall 50 passes through the gap between through-hole 54 and screw portion 41 from pilot hole 61 of battery connector BCN, and moves to plate front surface 71 side. The moisture that has moved to plate front surface 71 side is further caused to move from plate front surface 71 side to back surface 52 side (battery pack BP side); however, since liquid gasket 76 is disposed to surround through-holes 54 on plate front surface 71 side facing back surface 52, the moisture that has moved to plate front surface 71 side cannot move to back surface 52 side due to liquid gasket 76 (waterproof section). As a result, it is possible to prevent moisture adhering to the front surface 51 side of standing wall 50 from moving to the battery pack BP side. As a result, it is possible to achieve satisfactory water-tightness of battery connector BCN.

Further, in assembly structure 400 of the battery connector in the above embodiment, the waterproof section is disposed to fill the gap between plate front surface 71 and back surface 52. As a result, the moisture that has moved to plate front surface 71 side does not pass through the gap and thus cannot further move to back surface 52 side. As a result, since moisture does not move to the battery pack BP side, it is possible to further enhance the water-tightness of battery connector BCN.

Further, in assembly structure 400 of the battery connector in the above embodiment, head portion BLT1 is welded to plate front surface 71. As a result, moisture remains on plate front surface 71, and it is possible to prevent the moisture from moving from plate front surface 71 side to plate back surface 72 side, thereby further enhancing the water-tightness of battery connector BCN.

Further, battery unit BTR in the above embodiment includes the following: battery case BTRC including the above-described assembly structure 400 of the battery connector and accommodation section BSS that accommodates battery pack BP; and battery cover BCVR including standing wall 50 and disposed so that the back surface 52 side of standing wall 50 becomes the accommodation section BSS side. As a result, it is possible to prevent moisture such as rainwater adhering to battery connector BCN from entering accommodation section BCC from the battery connector BCN side.

Further, the support structure for the battery unit in the above embodiment includes a restraint member that restrains battery unit BTR in a state of battery unit BTR being drawn toward the vehicle side in such a way that when battery unit BTR is drawn toward the vehicle side with a predetermined force, the battery unit receives a reaction force against the predetermined force. As a result, battery BTR is restrained in a state where battery BTR is drawn to vehicle 1, and therefore, battery BTR does not move relatively with respect to vehicle 1, making it possible to prevent battery BTR from rattling due to vehicle vibration.

Further, in the support structure of a battery unit in the above embodiment, restraint member 10 is disposed to face both side positions of a location where battery connector BCN is disposed. As a result, battery unit BTR is restrained in a state where the both side positions of battery connector BCN are drawn toward vehicle 1 side, and the both side positions of battery connector BCN do not move relatively with respect to the vehicle. Therefore, connector CN, which is disposed at a position between the both side positions, also does not move relatively with respect to vehicle-side connector FCN disposed on vehicle 1 side, and thus, it is possible to reliably maintain the connection between the connectors.

Further, in the support structure of a battery unit in the above embodiment, the support structure includes first latch 11 as restraint member 10 that draws battery unit BTR toward vehicle 1 side via first striker STR1 disposed at one of the both side positions, and second latch 12 as restraint member 10 that draws battery unit BTR toward vehicle 2 side via second striker STR2 disposed at the other of the both side positions. As a result, it is possible to reliably draw the both side positions of battery BTR toward vehicle 1 side with first latch 11 and second latch 12.

In the above embodiment, liquid gasket 76 as a waterproof section disposed to collectively surround four through-holes 54 in assembly structure 400 of a battery connector has been described; however, the waterproof section in the present disclosure may be disposed to surround each of four through-holes 54, and is not limited to liquid gasket 76.

Further, the assembly location of battery connector BCN in the present disclosure can be appropriately changed according to the shape of battery cover BTRC (for example, the direction in which accommodation section BCC is opened), the disposition location of battery unit BTR with respect to vehicle 1, the vehicle structure, the specification of battery unit BTR, and the like. Further, when battery unit BTR is supported in a state where battery BTR is drawn toward vehicle 1 side, battery connector BCN is electrically connected to vehicle-side connector FCN, and thus, the assembly location of battery connector BCN can be changed according to the drawing direction.

Each of the above-described embodiment merely shows an example of specific implementation of the present disclosure, and the technical scope of the present disclosure should not be construed to be limited thereto. That is, the present disclosure can be implemented in a variety of ways without departing from the spirit or essential features thereof.

### INDUSTRIAL APPLICABILITY

The present disclosure is suitably utilized in a vehicle including an assembly structure of a battery connector that is required to have satisfactory water-tightness.

1. An assembly structure of a battery connector, the assembly structure comprising:
a battery cover that stores a battery pack and includes a standing wall provided with an opened through-hole extending from an outer side of the standing wall to an inner side of the standing wall;
a battery connector that is provided at the battery cover and includes a pilot hole at a position corresponding to the through-hole;
a fastener that includes a screw portion and a head portion; and
a plate that includes an outer surface to which the head portion is fixed at a position corresponding to the pilot hole,
wherein
the battery connector is fastened to the outer side of the standing wall by the fastener with the screw portion of the fastener passing through the through-hole and the pilot hole from the inner side to the outer side, and
the assembly structure further includes a waterproof section disposed between the battery cover and the plate so as to surround the through-hole.

2. The assembly structure according to claim 1, wherein
the waterproof section is further disposed to fill a gap between the outer surface of the plate and an inner surface of the standing wall.

3. The assembly structure according to claim 1, wherein:
the head portion is welded to the outer surface of the plate; and
the outer surface of the plate is formed to fill a gap between the outer surface and the head portion, and has a function as the waterproof section.

4. A battery unit comprising:
the assembly structure according to claim 1;
a battery case that includes an accommodation section accommodating the battery pack; and
a battery cover that includes the standing wall and is disposed so that the inner side of the standing wall is a side of the accommodation section.

5. A support structure of a battery unit, the support structure comprising:
a restraint member that restrains the battery unit according to claim 4 in a state where the battery unit is drawn toward a vehicle side so that, when the battery unit is drawn toward the vehicle side with a predetermined force, the battery unit receives a reaction force against the predetermined force.

6. The support structure according to claim 5, wherein
the restraint member is disposed to face both side positions of a location where the battery connector is disposed.

7. The support structure according to claim 6, further comprising:
a first latch as the restraint member drawing the battery unit toward the vehicle side via a first striker that is disposed at one of the both side positions; and
a second latch as the restraint member drawing the battery unit toward the vehicle side via a second striker that is disposed at another one of the both side positions.
